(19) United States
(12) Patent Application Publication
(10) Pub. No.: US 2014/0067607 A1
(43) Pub. Date: Mar. 6, 2014

(54) System and Method for Shared Interactive Network Platform for Real Estate Transactions

(71) Applicant: Shane Bryan, Canton, MA (US)

(72) Inventor: Shane Bryan, Canton, MA (US)

(21) Appl. No.: 13/596,631

(22) Filed: Aug. 28, 2012

(51) Int. Cl. G06Q 30/06; G06Q 50/16

(52) U.S. Cl. CPC G06Q 30/0623; G06Q 50/16
USPC 705/26.41

(57) ABSTRACT

An online computerized platform and method are presented for aiding members of a network related to real estate transactions. In some aspects users that are prospective buyers or renters can establish a user-centric network of service providers relating to real estate, including agents, loan entities, legal and labor services, and other relevant contacts in a custom network for such users. Directed automated and user-driven actions can define the network for a given member of the community of users so that the user's experience is user-centric rather than centered around the offerings of a given vendor such as around real estate or loan or service offerings.

### TECHNICAL FIELD

The present disclosure relates to a system and method for an online shared interactive network platform to facilitate business related to property transactions, including buying or leasing and including for real estate transactions.

### BACKGROUND

Different industries that are closely affiliated with the real estate industry or that are integral parts of it, such as real estate lawyers, mortgage brokers, movers, home renovators, etc. currently operate individual websites and may place advertisements on realtors websites.

A Multiple Listing Service (MLS) is a facility for the orderly correlation and dissemination of listing information to better serve real estate broker's clients, customers and the public. An MLS's database and software is used by real estate brokers, representing sellers under a listing contract to widely share information about properties with other brokers who may represent potential buyers or wish to cooperate with a seller's broker in finding a buyer for the property or asset.

Real estate brokers often show limited MLS information on their websites under a system known as IDX or Internet Data Exchange. Using IDX search tools available on most real estate brokers' websites (as well as on many individual agents' sites), potential buyers may view properties available on the market, using search features such as location, type of property (single family, lease, vacant land, duplex), property features (number of bedrooms and bathrooms), and price ranges. In some instances photos can be viewed. Many allow for saving search criteria and for daily email updates of newly-available properties. However, these services are generally property-based, or relating to attributes of the real estate itself.

Real estate websites that are not affiliated with a particular broker (e.g., Trulia, Zillow, Yahoo! Real Estate) can also provide an IDX listing database based on MLS, as well as news and information, and realtor and industry contacts. These websites generally show advertisements to fund their operations are also property-centric in their content.

More user-friendly services and systems are needed that can cater to the interests and environment of the user rather than revolving around the property, service, loan or other products being offered on a site.

### SUMMARY

As mentioned above, current IDX systems lack an intranetworking platform that can be used by buyers, realtors and service professionals to share contacts or information. Current systems also do not provide interactive user-friendly or integrated functions calendar management e.g. appointment update and event sharing capabilities, and they lack client and business relationship management tools.

A need exists for a new service and platform that will centralize the real estate industry and related services and products to better serve the consumer and community of service providers. A platform and method that are member-centered are disclosed herein. This can save companies on cost currently allocated to their individual personal, company, and property websites as well as service, storage and advertising fees. Also, this enables a convenient and useful way for a consumer (buyer, renter) to find and coordinate his or her real estate related service providers and vendors in a community that revolves around the individual and his or her needs and profiles.

In an embodiment, the present system and method can deliver one central network for one specific industry, in this case the real estate industry, to minimize confusion and costs and maximize the industry's efficiency.

A new real estate business shared, interactive, unified platform is presented that provides a “home office space” to members, and allows said members to most efficiently search properties, find professional contacts, build networks, share information, and process real estate transactions.

### BRIEF DESCRIPTION OF THE DRAWINGS

For a fuller understanding of the nature and advantages of the present invention, reference is be made to the following detailed description of preferred embodiments and in connection with the accompanying drawings, in which:

FIG. 1 shows a schematic diagram of the content and relationships between and within the basic databases underlying the currently presented application;

FIG. 2 shows an exemplary webpage depicting a user profile;

FIG. 3 shows membership categories and connections between members of a group within the network;

FIG. 4 shows some of the uses of interactive communication technology within the application; and

FIG. 5 shows a simplified schematic illustrating the tasks involved in an exemplary property purchase process as facilitated by the interactive communication technology in the currently presented application.

### DETAILED DESCRIPTION

Aspects of this invention provide a new platform that changes the real estate industry's landscape through an interactive media listing service and a shared networking capability. Members or users of the system will range from buyers or renters, hereafter also referred to as clients, realtors, real estate attorneys and mortgage brokers, through moving companies, building contractors, and other service and goods providers who stand to benefit from networking with this group. Each member can belong to multiple groups, where a group is generally self-defined by a mutual interest or transaction. User profile pages will provide an interconnected searchable hub of information content and are at the heart of the application.

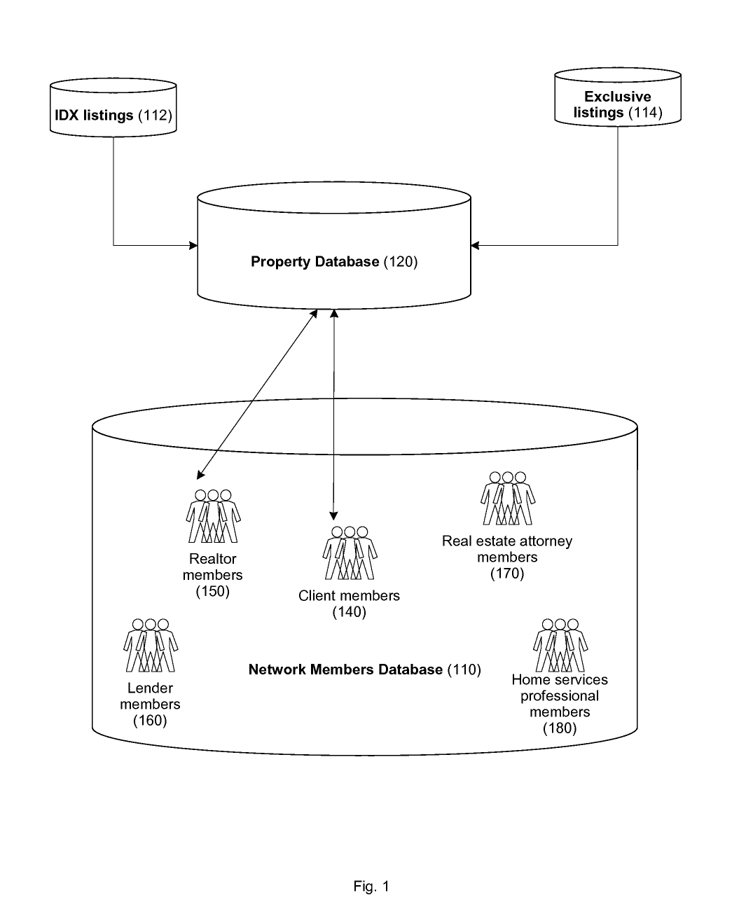

FIG. 1 shows a schematic diagram of the content and relationship between databases in the preferred embodiment of the currently presented system. The two main databases in this embodiment are: the members database 110, and the property database 120.

Other embodiments of the invention may include more databases, interconnected directly or indirectly through a communication network and hardware infrastructure. One example of which is a file repository that can store members' documents and online media to view and use when necessary. Files could be designated by the members who own them as private, or shared with one or more named members.

The member database 110 includes profiles of all the members and information about their groups and connections. Members are assigned to a category, which determines some of the built-in features of their customizable user profiles. A user profile will include customizable personal and contact information, and may include the following information or links to it: 1) members within a user's group; 2) shared and private calendar events, appointments and itineraries; 3) saved documents, either shared or private; 4) communication capabilities such as email, instant messages and communicator applications such as Skype® or similar applications; 5) a customizable bulletin board and relevant news features; 6) property search features with favorite and saved property listings.

Client members 140 are typically people who are looking to buy or rent a property. Realtor members 150 may have a transparent view of clients'favorite and saved listings and can work together with clients and other members using a built-in interactive communication platform. In one embodiment of the invention, client members 140 typically have a relationship with only one realtor member in the group of realtor members 150.

Other categories of members can be mortgage brokers and lenders 160, real estate attorneys 170, and home services professionals 180. Home services professional members may include but are not limited to interior designers, appraisers, contractors, architects, builders, landscapers, cleaners, plumbers, and movers. All service providers may occupy one category of membership, or, in some embodiments, different types of service providers, e.g. appraisers, may occupy a distinct membership category.

The property database 120 comprises sale and rental listings from MLS 112, and listings from other sources, that may include exclusive listings 114. The database is searchable by members using multiple criteria, such as price, location, etc.

When a member performs a property search, the preferred embodiment of the present system features a property match ranking functionality that assigns a numerical grade or “percent match” that reflects the quality of the match for each property, i.e. the percentage of requested criteria achieved per listing. The percent match sorting option can display property listing results in order of percent match. Known or new algorithms and techniques for determining a property match may be employed in the present system and method.

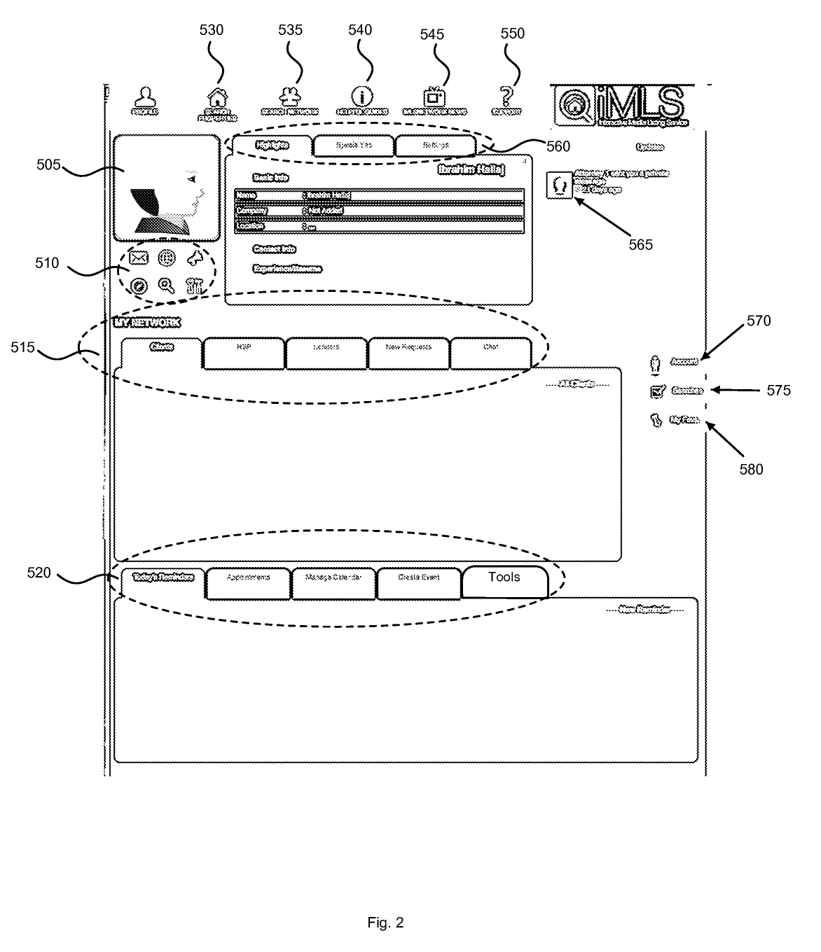

An example of a possible customizable webpage displaying a member's profile and links is shown in FIG. 2. In this particular case the member is a realtor, therefore some of the tabs and other hard-coded features in the profile are specific to that membership category. Features of the webpage may include a photo 505, and links to applications such as mail, and profile editing 515. In addition, tabs show links information about other members of the realtors group, sorted according to category 515. Other tabs may activate tools such as a calendar or mortgage calculator 520. A search window for properties is opened by using button 530. Button 535 opens a search box within the network. General information related to property transactions and real estate is found by pressing the button 540. Button 545 delivers real estate news, while button 550 links to customer support. Tabs related to profile information, characterizing the member's basic contact information may also include professional experience 560. An area of the page shows notices on the bulletin board 565. The member's account information is readily accessible 570, as well as saved property searches and property favorites 575, 580.

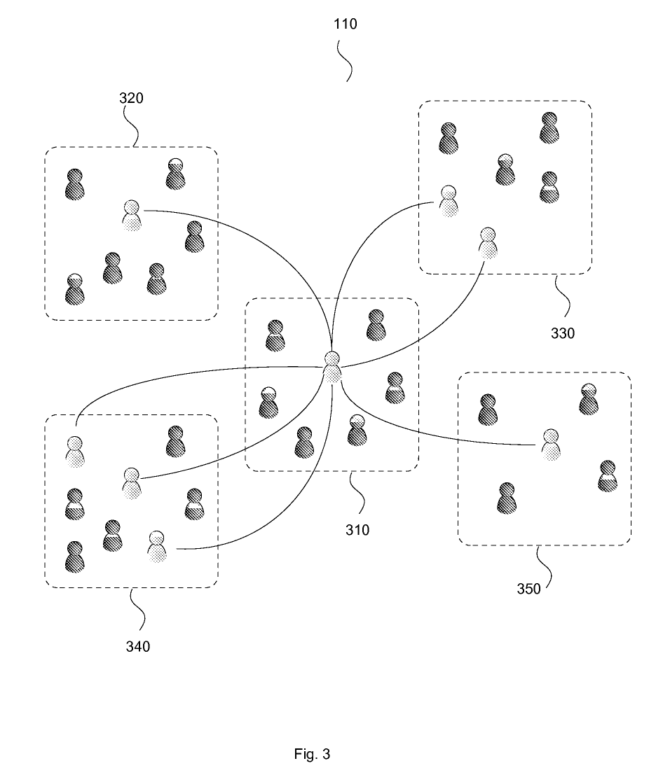

FIG. 3 shows an example of connections between a group of members from different categories in the network members database 110. In this example, the group is formed by a member whose profile resides in the category of clients 310, as indicated by a dotted line surrounding these types of members. The dotted lines 320, 330, 340, and 350, enclose members who belong to different categories. The number of members in each category may be variable, as is the number of members that are connected in a group.

An integral part of the invention is the interactive communication technology that in some aspects allows direct, confidential, and secure communication between all members, and easy sharing of information. The flow of information and the real or virtual network created to connect the hubs and spokes of the interactive parts of the system are member-centric and may be automated or member-driven to provide the environment desired to serve the member's needs.

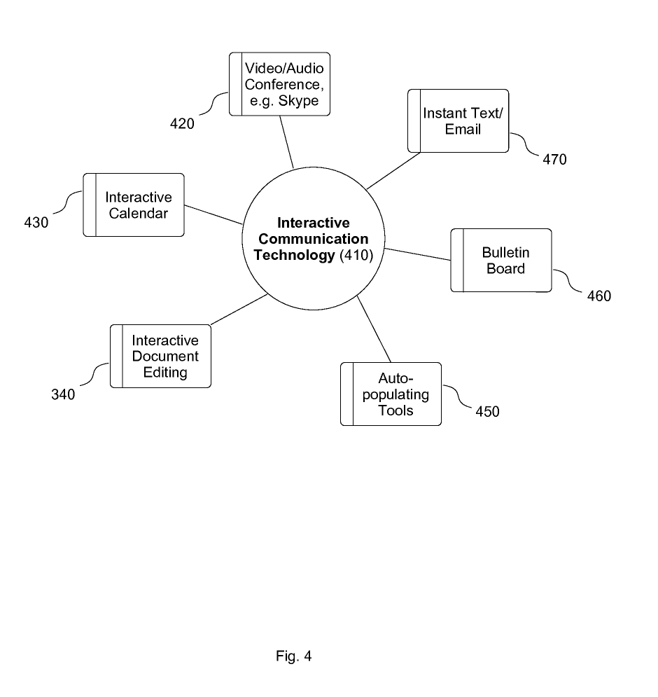

FIG. 4 shows some of the ways in which the interactive communication technology 410 is used in an embodiment of the invention. Members can communicate via video/audio conference 420, and via instant text messages or email 470. For dissemination of information to multiple members, bulletin boards 460 can be utilized. Members can collaboratively set up their profiles and share calendar listings 430. In some embodiments, documents can be looked at simultaneously by multiple parties, or worked on together 440. Tools and calculators 450 can have fields that are filled in by group members either manually or automatically. One example of this is a mortgage calculator for use by a client member, in which daily interest rates for different loan products are filled in by a lender member.

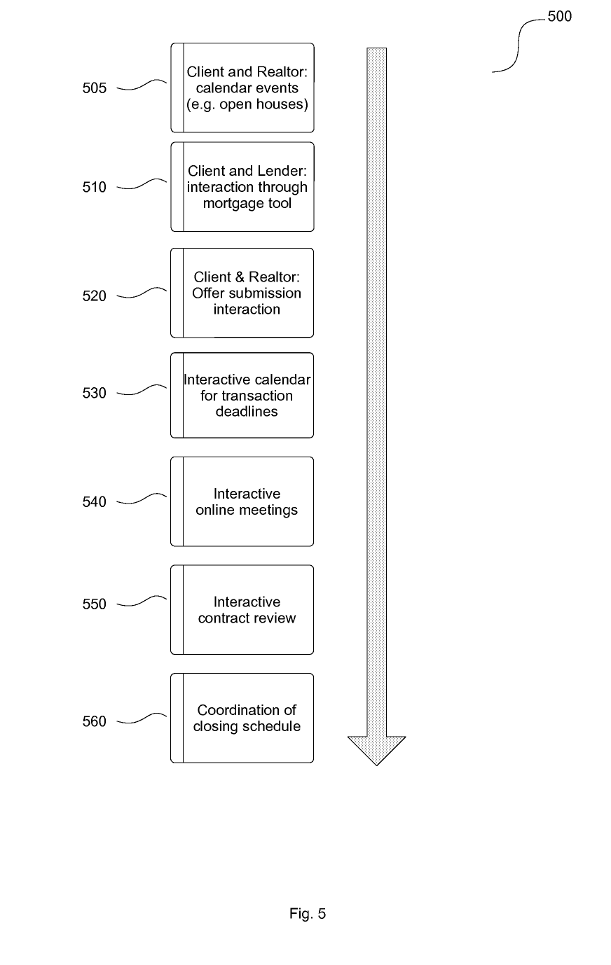

As well as being useful for enabling interactions, and searching for property, the website serves to guide the client and the other members through the buying process. FIG. 5 shows a simplified example of the possible steps in the process of property purchase 500 as facilitated by the present system.

Step 505: A buyer and realtor communicate through the website to find properties, compare them to similar properties, and then set up viewing schedules using the interactive communication technology 410.

Step 510: After the lender works with the client to generate a loan preapproval document, they interactively calculate mortgage payments using the mortgage tool.

Step 520: The client finds a property he/she wishes to buy and after conferring online with the realtor, submits an offer.

Step 530: After agreement documents are drawn up by the attorneys, the interactive communication technology 310 allows a calendar containing the various transaction deadlines to be shared among all the relevant parties.

Step 540: Online meetings occur to discuss the transaction.

Step 550: An interactive review of documents by the attorney, realtor, client and lender takes place.

Step 560: Closing—the closing schedule is interactively set up.

Although this description includes most of the major steps of a property acquisition, additional interactive steps may be need and are obviously able to be included in this framework. In the case of property rentals, similar, although usually less complex, transactions can be facilitated. Therefore, the example provided above is to be understood as illustrative and not limiting in the order or identity of the specific tasks carried out. Those skilled in the art will appreciate proper useful extensions and modifications of the exact described embodiments to many others that are equally useful and equivalent.

A business model of a preferred embodiment of the present network application may be based on subscriber fees paid by the members rather than advertising revenues, which are not generally beneficial to the members. This is not to exclude such advertising, e.g., targeted advertising on the platform in some embodiments. Real estate service professionals and service providers can showcase their products and services in front of consumers who are in the market for their products thus ensuring a high rate of return on investments.

Therefore, in some embodiments, there is provided a computerized platform system for providing property related services, comprising a subscribing member database containing profiles of each member of a community of subscribing members; a property database containing attributes of a plurality of properties; a member-specific portion of said subscribing member database including, for a given member, a list of a plurality of other members which the given member has chosen to be in his or her member-specific network; a member-specific portion of said property database including, for a given member, a list of properties which the given member has chosen to be in his or her member-specific property list; an electronic document generator that generates and serves pages, to a given member, relating to property transactions for a property in the member's member-specific property list as provided by subscribing members in the given member's member-specific network. The electronic document or page may comprising a HTML or XML (e.g., Web) page created to suit the member's needs. Here a subscriber can determine their own experience in using the platform because he or she custom selects their network of providers and their list of properties of interest, among other features.

Some of these features include interactive communication and messaging with other subscribing members of the member's member-specific network. Other features include interactive calendaring between members in a member-specific network allowing the members to set dates for property-related transactions, meetings, showings and so on. Yet other features allow the members of a member-specific network or group to interactively or collaboratively create or modify electronic documents.

Other embodiments of the present invention provide a computerized online method for facilitating property related transactions, comprising providing a computerized platform to a community of subscribing members, providing the platform including providing access to hardware, databases, software programs and stored data substantially dedicated to executing functions property related transactions; compiling a database of subscribing members, said database of subscribing members containing member profiles for each member, each member profile including the member's attributes as they relate to property transactions; identifying for each member whether the member is in need of professional services relating to property or provides professional services relating to property; providing to the community of subscribing members a searchable database of available properties, including information about each property; enabling a member to select certain properties or classes or properties from said database of properties so as to create a member-specific property list; enabling a member to selectively choose from the community of subscribing members a subset of such members so as to create a member-specific network of other members of the database; displaying to a member one or more other members from the member's member-specific network as well as one or more or properties from the member's member-specific property list; and enabling communication between said member and said one or more other members from the member's member-specific network relating to said one or more properties from the member's member-specific property list.

The embodiments and description and drawings provided herein are illustrative and allow those skilled in the art to understand the inventions and to incorporate the inventions into systems and methods comprehended by the present disclosure and claims. The present embodiments should therefore not be considered exhaustive or limiting, but other derivative and similar techniques and devices relating hereto should be considered covered by the present scope of invention as well.

What is claimed is:

1. A computerized online method for facilitating property related transactions, comprising:
providing a computerized platform to a community of subscribing members, providing the platform including providing access to hardware, databases, software programs and stored data substantially dedicated to executing functions property related transactions;
compiling a database of subscribing members, said database of subscribing members containing member profiles for each member, each member profile including the member's attributes as they relate to property transactions;
identifying for each member whether the member is in need of professional services relating to property or provides professional services relating to property;
providing to the community of subscribing members a searchable database of available properties, including information about each property;
enabling a member to select certain properties or classes or properties from said database of properties so as to create a member-specific property list;
enabling a member to selectively choose from the community of subscribing members a subset of such members so as to create a member-specific network of other members of the database;
displaying to a member one or more other members from the member's member-specific network as well as one or more or properties from the member's member-specific property list;
enabling communication between said member and said one or more other members from the member's member-specific network relating to said one or more properties from the member's member-specific property list.

2. The method of claim 1, said property related transactions comprising real estate property transactions.

3. The method of claim 2, said member profiles including identification of a member as a user who wishes to buy or rent a property.

4. The method of claim 2, said member profiles including identification of a member as a real estate agent or person offering a real estate property for sale or rent.

5. The method of claim 1, further comprising automatically executing a matching routine to match a first member with other members whose attributes complementing the first member's profile.

6. The method of claim 1, further comprising automatically executing a matching routine to match a member's attributes and profile with one or more properties complementing the profile of said member.

7. The method of claim 1, said member-specific network comprising only other subscribing members selected by said member.

8. The method of claim 1, further comprising allowing only paying members into the community of subscribing members.

9. A computerized platform system for providing property related services, comprising:
a subscribing member database containing profiles of each member of a community of subscribing members;
a property database containing attributes of a plurality of properties;
a member-specific portion of said subscribing member database including, for a given member, a list of a plurality of other members which the given member has chosen to be in his or her member-specific network;
a member-specific portion of said property database including, for a given member, a list of properties which the given member has chosen to be in his or her member-specific property list;
an electronic document generator that generates and serves pages, to a given member, relating to property transactions for a property in the member's member-specific property list as provided by subscribing members in the given member's member-specific network.
